(19) United States
(12) Patent Application Publication
(10) Pub. No.: US 2018/0321775 A1
(43) Pub. Date: Nov. 8, 2018

(54) HETEROGENEOUS MEDIA PLAYER

(71) Applicant: Hey Platforms DMCC, Dubai (AE)

(72) Inventors: Nadim Basha bin Mohamed Al Qubaisi, Dubai (AE); Anthony Webb, Dubai (AE); Anthony Stephen Clarke, Dubai (AE); Darryl Haydn Jones, Dubai (AE)

(21) Appl. No.: 15/585,443

(22) Filed: May 3, 2017

(51) Int. Cl. G06F 3/048; G06F 17/30

(52) U.S. Cl. CPC G06F 3/048; G06F 17/30905

(57) ABSTRACT

A media player on a mobile device renders heterogeneous playlists having songs or other entries of different formats, and which correspond to different players. The unified heterogeneous media player identifies playlist entries and invokes a corresponding player through a graphical user interface (GUI). The GUI presents a single interface to the user, selects and invokes a player corresponding to the playlist entries, and remains under the control of the common GUI for providing a consistent user experience. A media server coupled to the mobile device transmits an identifier or title and a source of the media. The media server also stores and/or transmits related information for enhancing the user experience with news, lyrics and images based on the rendered entry. The unified media player invokes a messaging interface of the corresponding player for streaming the content based on the source, and also tenders the related information concurrently.

### BACKGROUND

Media players are a common and popular addition to mobile devices, as well as other types of computer rendering devices. Internet sites available for download of media, such as music, videos and full length films, are plentiful and growing. Many sites promote media such as music selections on a fee-for-services, while others allow less restrictive access. Evolution of these types of sites, as well as the types and format of available media has been rapid and generally unstructured. Accordingly, there are many storage and encoding formats available for rendering streamed audio and video content. Users often install and launch multiple media rendering applications (apps) in order to render the various types of downloaded media.

### SUMMARY

A media player on a mobile device renders heterogeneous playlists having songs or other entries of different formats, and which correspond to different players. A unified heterogeneous media player identifies playlist entries and invokes a corresponding player through a graphical user interface (GUI). The GUI presents a single interface to the user, selects and invokes a player corresponding to the playlist entries, and remains under the control of the common GUI for providing a consistent user experience. A media server coupled to the mobile device transmits an identifier or title and a source of the media. The media server also stores and/or transmits related information for enhancing the user experience with news, lyrics and images based on the rendered entry. The unified media player invokes a messaging interface of the corresponding player for streaming the content based on the source, and also tenders the related information concurrently. Successive entries corresponding to other players are invoked similarly, such that the playlist entries need not emanate from the same source. The resulting user experience allows uninterrupted rendering of playlists from different Internet sources and formats along with related information about the artist, title or group, providing a unique integrated user experience.

Configuration herein are based, in part, on the observation that media playlists for songs and other entries are popular enhancements to mobile devices for organizing the entries according to artist, genre or any other aggregation defined by the mobile device user. Users often build custom playlists based on personal preferences, or may simply select individual entries for immediate playback. Unfortunately, conventional approaches to playlist management suffer from the shortcoming that entries are specific to the source from which they emanate, such as iTunes®, Youtube™ and SPOTIFY®. Each source has a specific player for rendering entries from that source (site). Individual conventional playlists must be created for each source from which a song of entry is desired, and entries cannot be mixed with entries of other sources in the same playlist. Thus, the user is confronted with not only identifying entries for a playlist, but must also find a single source that includes all the desired entries in order to create a playlist. This leads to incomplete and multiple playlists as users are forced to group playlists based on different sources.

Accordingly, configurations herein substantially overcome the above described shortcomings by providing a heterogenous media player that can aggregate entries emanating from multiple sources, and invoke an interface corresponding to each entry for rendering. The unified, heterogenous media player therefore receives a playlist having heterogeneous entries from different sources, and renders each entry by invoking the corresponding player with a message interface for rendering the entries in succession.

Configurations herein therefore provide a single uniform control and playback graphical user interface (GUI) to seamlessly blend media types with vastly differing playback technologies, interfaces, and API's into a single playlist. The disclosed approach includes a method for organizing and rendering media files, by identifying, for each of a plurality of entries on a playlist, a source for rendering content defined by each entry in the plurality of entries, such as iTunes®, Youtube™ or Spotify®, for example. An app on the mobile device determines, for each entry, a corresponding player compatible with the entry for rendering the content, and instantiates the corresponding player, in which the corresponding player is responsive to a common graphical user interface (GUI) for exchanging rendering commands. The common GUI receives, from the identified source, the streamed content for rendering and directing the content to the corresponding player. The GUI exchanges messages with the corresponding instantiated player for rendering the entry, renders the received content via the corresponding player.

The disclosed approach provides capability for unifying disparate third-party player API's under a single meta-API within a web-browser, and for controlling disparate third-party players with a single unifying graphical user interface control system within a browser. Other features include a method for identifying the third-party player so as to select the correct API adapter, and a method for presenting third-party players in a consistent graphical user interface. Suitable storage provided by either an SSD (solid state drive or rotational media) provides storage of the disparate third-party media references and meta-data together in a single storage container as a playlist. Alternatively, emerging and future storage mediums such as Trans Flash, dynamic memory such as cloud storage, and any suitable storage technology now known or later developed is suitable for storage of the homogeneous playlist.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a rendering environment suitable for use with configurations herein;

FIG. 2 is a flowchart of rendering operation in the environment of FIG. 1;

FIG. 3 is a block diagram of player operation according to the flowchart of FIG. 2

FIG. 4 is a data flow diagram of operation in the block diagram of FIG. 3; and

FIGS. 5A and 5B are a flowchart of GUI operation for invoking the player of FIG. 3.

### DETAILED DESCRIPTION

Configurations depicted below present example embodiments of the disclosed approach in the form of a mobile device having an application (app) for implementing the heterogeneous player, a media server for locating the playlist entries, and a supporting network for transmission. Other forms of the example approach may be implemented, as variation in the depicted hardware and network arrangement may be apparent without departing from the novel approach disclosed herein.

The approach depicted below takes note of the fact that while there exists only a modest number of common media formats used for playback in web browsers, web-sites frequently wrap such media in a bespoke player for purposes of, inter-alia, branding, copyright enforcement, and tracking. Conventional users may need to be concerned with rendering unauthorized or proprietary material by rendering through improper conduits. This creates a problem for both viewers and aggregation sites in that bespoke players do not conform to any commonly agreed API standard. In some cases, to create a feeling of homogeneity, web-sites will transcode or re-encode such media leading to a reduction in the quality of the media, leave the web-site open to possible copyright infringement claims, and increase costs due to computationally expensive algorithms. The method describes a technology to unify heterogeneous media sources into a single player which uses the original media source, maintains the originating player functions and branding, and creates a common interface for interacting with heterogeneous collections of media assembled by users into playlists with typical control features users expect such as skip, scrub, select, and randomize in a common graphical user interface (GUI). In addition, the method avoids copyright claims by the content originator by streaming, rather than storing, and avoids the computationally expensive process of transcoding or re-encoding media. Similarly, media rendering will not obfuscate advertising or watermarks intended to be conveyed by the copyright owner, licensee, or contractual oblige of the rendered media, so as to avoid deterring usage from fear of undermining property rights of others.

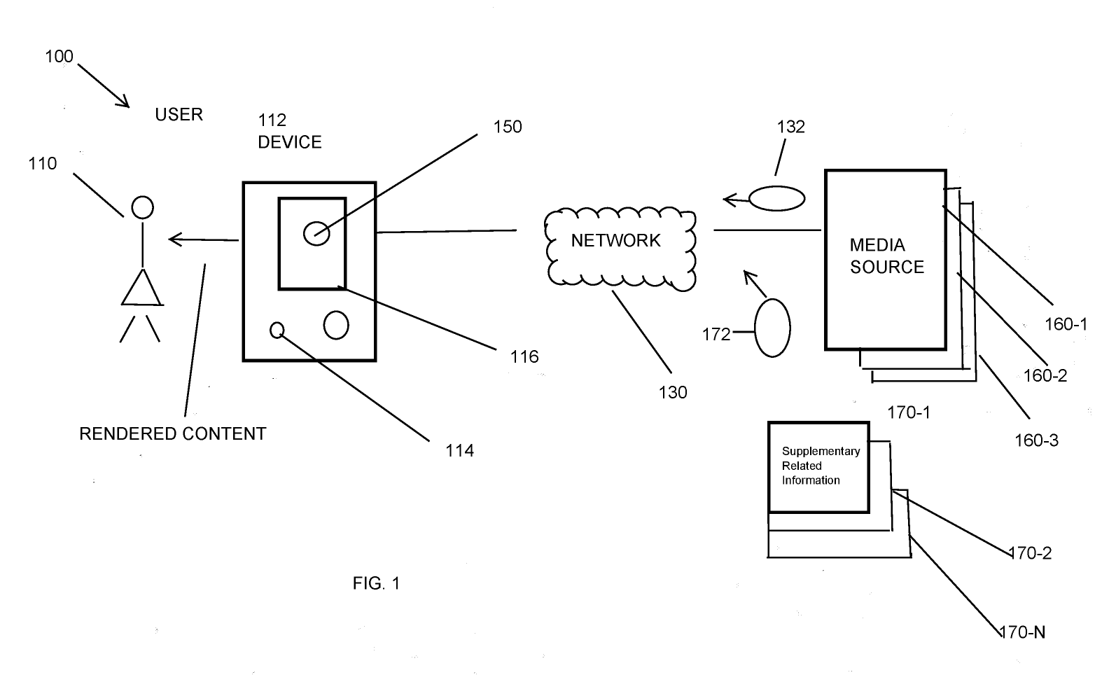

FIG. 1 is a context diagram of a rendering environment suitable for use with configurations herein. Referring to FIG. 1, in a rendering environment 100 a user 110 employs a personal device 112 such as a mobile phone, smart phone, tablet, laptop or other personal mobile or stationary electronic device suitable for rendering audio and visual streams. The personal device 112 connects to a public access network 130 such as the Internet by any suitable wired or wireless mechanism, and includes an application (app) 150 for receiving media content and rendering audio and video via respective speaker 114 and screen 116, as such personal devices 112 are often employed for.

It should be noted that the personal device 112 also represents any suitable consumer of the rendered media content as disclosed herein. The media content may be received and consumed (rendered) by any suitable device (mobile, laptop, tablet, desktop, etc) and may be received by a browser implementing the disclosed approach, or by an app (application) configured for receiving and rendering. Both an app and a browser executing an HTML or Java application, for example, are configurable for consuming renderable media content as described below.

The app 150 receives content 132 from a plurality of media sources 160-1 . . . 160-N (160 generally) via the network 130. Content 132 includes various media such as audio, video, or a combination. In addition to streamed audio often requested by conventional devices, the app 150 also receives streamed video from the sources 160, and also receives related information 172 and static content such as lyrics, news, blog entries and other information based on or related to the content from other remote information sources 170-1 . . . 170-N (170 generally), typically website search results. The app 150 receives the content 132 (typically streamed) and related information sources 170 (typically static or text entries), and renders both in a unified manner on the device 112.

The content 132 requires a particular player or rendering app for properly rendering that content 132. The app 150 includes a heterogeneous media player, discussed further below, that invokes a corresponding player based on the media source 160 and type of the content 132. Playlists having content from different sources 160, and having different player requirements, may nonetheless be stored and rendered as a single playlist due to the heterogeneous nature of the player in the app 150.

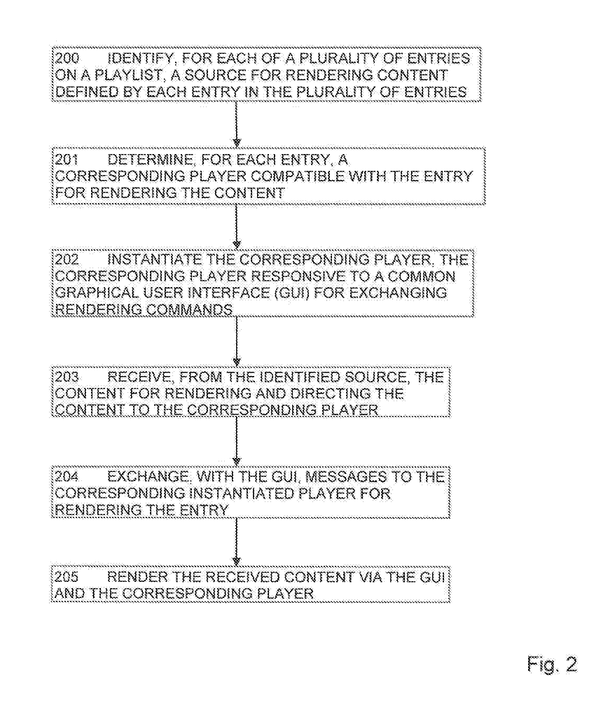

FIG. 2 is a flowchart of rendering operation in the environment of FIG. 1 according to configurations herein. Referring to FIGS. 1 and 2, the method for organizing and rendering media files includes, at step 201, identifying, for each of a plurality of entries on a playlist, a source 160 for rendering content defined by each entry in the plurality of entries. The sources 160 are websites having content such as songs for download, and may be password protected and/or fee based. The device app 150 (app) determines, for each entry, a corresponding player compatible with the entry for rendering the content, as shown at step 202. The app 150 instantiates and/or invokes the corresponding player, such that the corresponding player is responsive to a common graphical user interface (GUI) for exchanging rendering commands for providing a consistent user experience for controlling the media, as disclosed at step 203. The mobile device 112 receives, from the identified source 160, the content 132 for rendering and directing the content to the corresponding player, as depicted at step 204. The player exchanges, with the GUI, messages to the corresponding instantiated player for rendering the entry responsive to user input, as disclosed at step 205, and renders the received content 132 via the GUI and the corresponding player, as disclosed at step 206. The GUI and corresponding player, as indicated above, may be fulfilled by any suitable consuming entity, including a browser or a dedicated app, which executes on any suitable consuming device, as described above. By matter of convention, specialized apps designed for accommodating the limited control and rendering region of a mobile device may be easier to operate than a generalized browser. Similarly, desktop users may prefer a browser based interface so as to avoid the need to install and learn a dedicated consumer app, however the origin of the rendering instructions (browser or app) and the hardware it is launched on are more a matter of user preference.

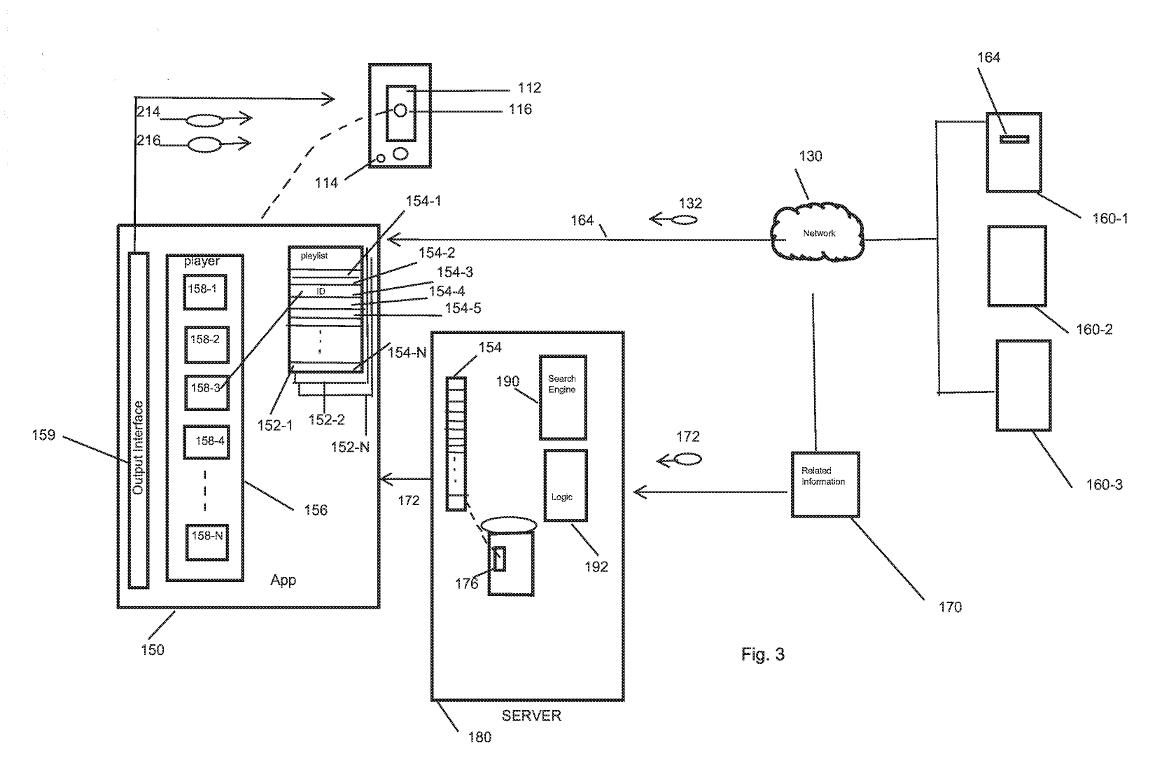

FIG. 3 is a block diagram of player operation according to the flowchart of FIG. 2. Referring to FIGS. 1-3, the app 150 launches and executes on the device 112 for rendering audio 214 and video 216 for a user 110 experience. Aggregation of the audio 214 and video 216 integrates and coalesces visual and audio information from the media sources 160 and related information sources 170 for a different user experience than conventional streaming of the audio or video track.

The app 150 stores playlists 152-1 . . . 152-N (152 generally), each containing entries 154-1 . . . 154-N (154 generally) of songs or other media entries which refer to content 132. In contrast to conventional playlists, in which each entry 154 is based on a common source designed to be played by the same media player, each entry 154 is independent of the player and heterogeneous entries 154 from different sources 160 and having a different format for playback from a particular media player may be included. Each entry 154 (song or other content type) has a corresponding source 160 including the stored content 164, and a media server 180 catalogs each entry 154′ for transmission and arrangement on a playlist 152 on the device 112. While the identity and source 160 defined by the entry 154 exists on the media server 180, actual rendering or playback commences from the source 160 as the stored content 164 is streamed 164′ to the device 112 directly from the source as a stream 164′, and is not stored on the media server 180. The content 132, therefore, including the actual audio or video data (e.g. MP3, MP4, .WAV, GSM, Podcasts, etc.) is transmitted as the stream 164′. It is important to distinguish between a codec, which the player 158 uses to decode the data for rendering, from a container or file in which the encoded data is stored.

Related information 172, such a lyrics, news and text or static entries, may be stored in the media server 180 in conjunction with the entry 154′, depending on copyright and licensing restriction such as memory residence limits. The related information 172 is integrated for simultaneous rendering (typically as video accompanying the audio) on the device 112.

On the device 112, the app 150 invokes the heterogeneous player 156, which identifies a player interface 158-1 . . . 158-N (158 generally) corresponding to a particular entry 154, and invokes the corresponding player 158 via an output interface 159 to deliver the stream 164′ as content 132. The output interface 158 connects to the speakers 114 and display 116 for displaying the audio content 214 and video content 216 simultaneously.

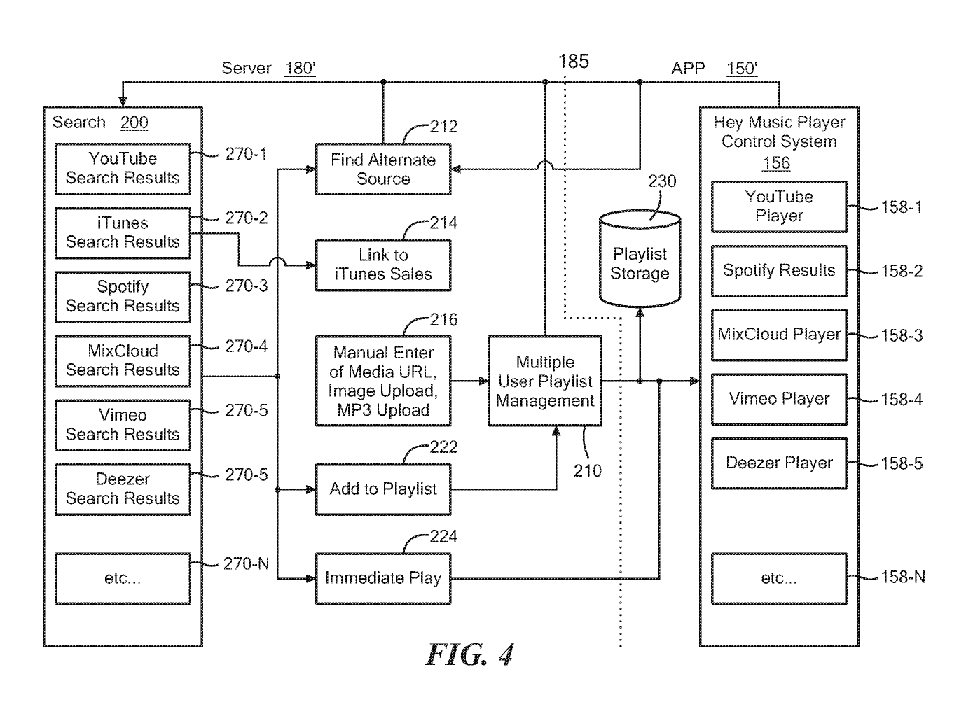

FIG. 4 is a data flow diagram of operation in the block diagram of FIG. 3. Referring to FIGS. 3 and 4, data flow, an example data flow of a particular configuration is shown. A demarcation between media a media server side 180′ and an app side 150′ is shown by dotted line 185, although certain data flows may occur on either side. A search engine 200 traverses and gathers search results 270-1 . . . 270-N from available Internet information sources 170. Depending on the server management logic 192, the server 180 may find alternate sources 212 for content that is password protected or copyrighted, or otherwise provides improved results (more efficient decoding, etc.)

The search results 270 are used to define each content entry 154, and denote the location of the song or other content 132, typically a URL (uniform resource locator) on the network 130. The search results 270 also identify related information 172, and store related information in a media entry 154′ corresponding to the playlist entry 154. The media entry 154′ may be transferred to the device 112 upon a response to a GUI request for building a playlist 154 and/or rendering the content 132 denoted by the playlist entry 154. Playlists 152 may be built by individual users by aggregating individual playlist entries 154, or entire playlists 152 may be downloaded from playlist management 210. Playlist storage 230 may maintain playlists 152 locally on the device 112, or alternatively on the server 180 for download. In this manner, media entries 154′ include the source 160 of the stored entry 164 and the related information 172. The playlist entry 154 includes the location (source 160) of the stored content 164, for streaming as content 132 to the device 112. The server 180 also stores related information 172 for transmission 172′ to the device 112 upon rendering the stream 164.

Other paths for obtaining entries may be via itunes® sales 214 and manual entry 216. Each entry 154′ found by the server, therefore, is available to add 222 to a playlist 152 (either on the user device 112 or server). Alternatively, entries 154′ may be sent to the device 150 for immediate play 224.

On the device 112, upon selection of an entry 154 for playback, the heterogeneous player 156 invokes the corresponding player 158 for rendering the entry 154.

The operation of the heterogeneous player 156 may be better described by successive plays of two distinctly sourced playlist entries. In such a scenario, the app 150 determines a first corresponding player that is compatible with a first entry for rendering the content defined by the first entry, and determines a second corresponding player compatible with a second entry for rendering the content defined by the second entry. Upon commencement of playback (rendering), the app 150 renders the received content defined by the first entry, and then renders the received content defined by the second entry, such that the first corresponding player is different than the second corresponding player. The heterogeneous player 156 in the app 150 invokes the respective corresponding player 158 based on the source 160. In the example configuration, determining the corresponding player 158 may include mapping the entry to the corresponding player from among a plurality of players. The plurality of players is also selectively invokable in response to other entries of the plurality of entries available for playback. Other mechanisms, such as lookups or indexing, may be employed to associate and invoke the proper corresponding player 158.

The heterogeneous player 156 is responsive to the common GUI for providing the user with a consistent rendering experience. The GUI has common controls for playback, stop, pause, skip, etc. which are then translated or otherwise activated in the native player 158. The app 150 identifies a plurality of players 158 for availability as the corresponding player, and determines, in an invokable interface for each player 158 of the plurality of players 158-N, a set of commands for controlling rendering of the content, in which the invokable interface is responsive to the commands from the GUI, and the GUI adapted to issue commands to each of the players 158 in response to user input.

In a particular configuration, the invokable interface is defined by a set of messages, such that each of the players 158 is configured for rendering media from a corresponding source 160 based on the defined set of messages. Since each native player 158 is different and is derived or downloaded from the corresponding source 160, each invokable interface defines a set of messages independent and different from invokable interfaces defined for other players of the plurality of players. The invokable interface may include any suitable interface published or available for the native player 158, in addition to the messaging interface. Such interfaces include aspects such as callable functions, interrupts, entry points, shared memory and other suitable IPC (interprocess communication) mechanisms.

In the messaging interface disclosed, instantiating the players may further include launching the GUI, such that the GUI is responsive to user commands directed to the rendered content (i.e. play, pause, etc.), and invoking a player 158 interface for each of the players corresponding to the sources of the plurality of entries, in which the GUI is configured to direct content playback control messages to the player interface corresponding to the source of the content currently being rendered. The players 158 may be invoked or launched at any suitable time, either on-demand as a corresponding entry is rendered, or instantiated upon startup pending a rendering request.

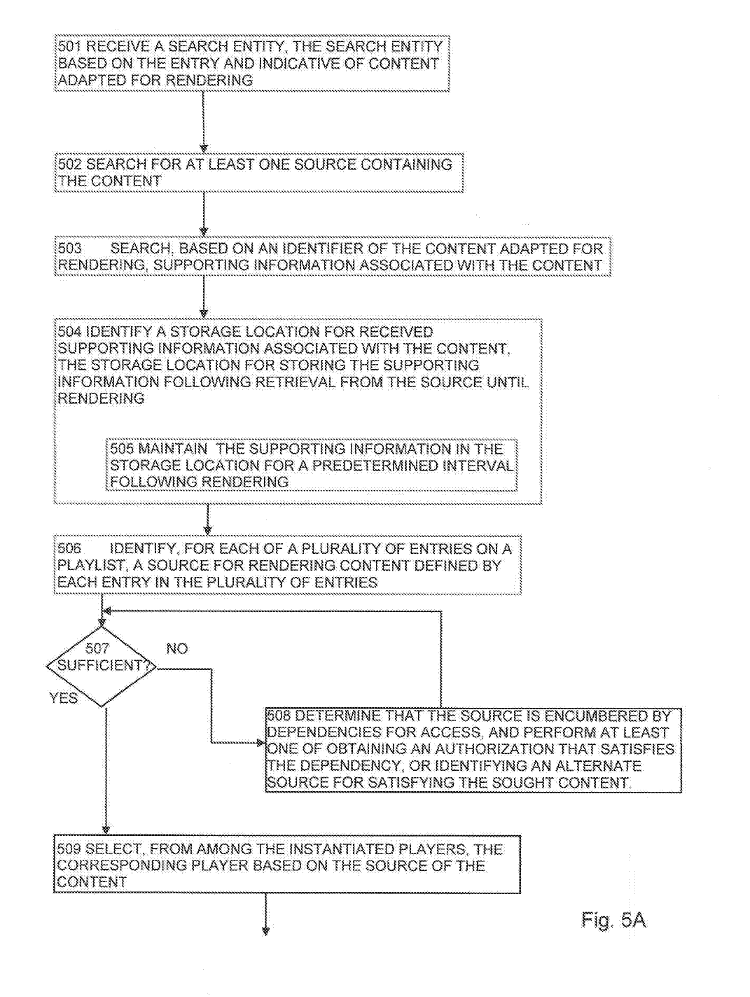

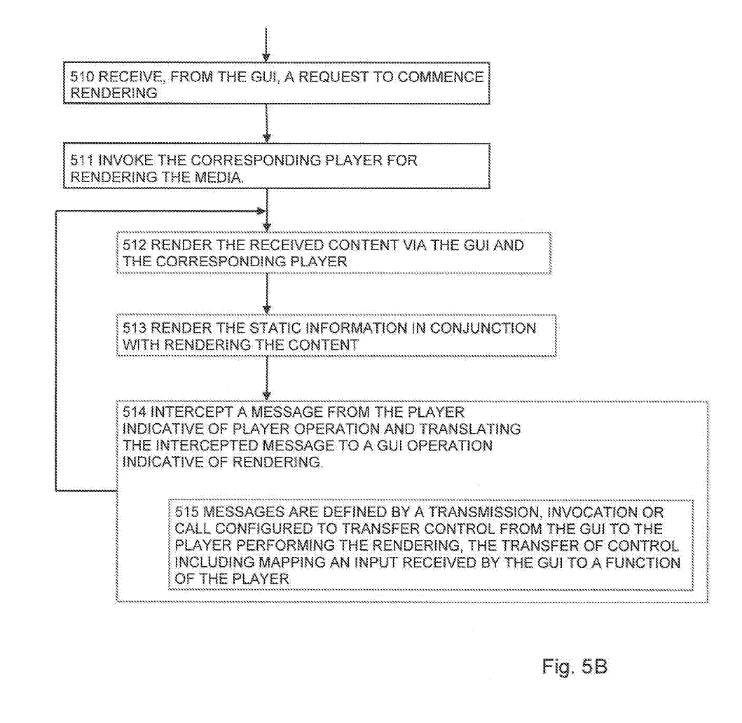

FIGS. 5A and 5B are a flowchart of GUI operation for invoking the player of FIG. 3. The depicted flowchart presents but one example scenario of operation; other operational paths and sequences may be derived based on the controls and media content landscape as described above. Referring to FIGS. 3-5, at step 501, the media server 180 receives a search entity such as a song title, in which the search entity is based on an entry 154 and indicative of content adapted for rendering. The media server 180 searches for at least one source 160 containing the content, typically a media streaming service as described above.

The search engine 190 searches, based on an identifier (ID) of the content, such as a song title, for both content sources 132 and supporting information 172 associated with the content. The search engine 190 receives a search entity, the search entity being an identifier (ID) such as a song title based on the entry and indicative of content adapted for rendering. Therefore, the user experience involves both the media content itself, such as an audio file containing a song, and supporting information such as lyrics, artist news, or images related to the song. The media server 180 searches for at least one source 160 containing the content, depicted at step 502, and then searches, based on an identifier (such as a title) of the content adapted for rendering, supporting information associated with the content, as shown at step 503. The player 158 is configured to locate and retrieve the content in a stream of information, as streams are efficient for transporting audio and video information. The stream typically remaining impersistent during rendering, meaning that it need not be stored locally on either the device 112 or on the media server (i.e. in a file), but rather is rendered/displayed upon receipt and soon followed by another packet of stream information.

The supporting information, in contrast, may be static and is stored on the media server 180 for transmission and rendering with the content to which it applies. Thus, the server 180 identifies a storage location 176 for received supporting information associated with the content, as depicted at step 504, such that the storage location is for storing the supporting information 172 following retrieval from the information source 170 until rendering. The server 180 maintains the supporting information in the storage location for a predetermined interval following rendering, so as to not run afoul of any copyright, contractual or other restrictions associated with its download, as disclosed at step 505. The content is then deleted from the storage location prior to expiration based restrictions.

The app 150 identifies, for each of a plurality of entries 154 on a playlist 152, a source 160 for rendering the content 132 defined by each entry in the plurality of entries, as depicted at step 506. A check is performed, at step 507, to identify if the source is sufficient for streaming the content 132, based on performance or cost factors. The app 150 may determine that the source 150 is encumbered by dependencies for access, and perform at least one of obtaining an authorization that satisfies the dependency, or identifying an alternate source 160 for satisfying the sought content, as depicted at step 508.

Once a sufficient source 160 is found, the heterogeneous player 156 selects, from among the instantiated players 158, the corresponding player based on the source 160 of the content, as depicted at step 509.

The app 150 receives, from the GUI, a request to commence rendering, as shown at step 510, and invokes the corresponding player 158 for rendering the media content 132, as depicted at step 511. The invoked player 158 renders the received content 132 via the GUI and the corresponding player 158, as depicted at step 512. Concurrently, the GUI renders the static or related information 172 in conjunction with rendering the content 132, as shown at step 513. Upon reaching the end of the content 132 defined by the entry 154, or if receiving a GUI command prior to the end, the app 150 intercepts a message from the player 158 indicative of player operation and translates the intercepted message to a GUI operation indicative of rendering, as depicted at step 514. In other words, the GUI converts user input to correspond to the native player 158. This would either be to advance to the next playlist 154 entry, or for another GUI command message between the GUI and the player 158. The messages are defined by a transmission, invocation or call configured to transfer control from the GUI to the player 158 performing the rendering, in which the transfer of control includes mapping an input received by the GUI to a function of the player 158, as depicted at step 515. Control reverts to step 512, and play will simply proceed to the next entry 154 in the playlist 152 as described above, or by other action according to the GUI command.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for organizing and rendering media files, comprising:
identifying, for each of a plurality of entries on a playlist, a source for rendering content defined by each entry in the plurality of entries;
determining, for each entry, a corresponding player compatible with the entry for rendering the content;
instantiating the corresponding player, the corresponding player responsive to a common graphical user interface (GUI) for exchanging rendering commands;
receiving, from the identified source, the content for rendering and directing the content to the corresponding player;
exchanging, with the GUI, messages to the corresponding instantiated player for rendering the entry; and
rendering the received content via the GUI and the corresponding player.

2. The method of claim 1 further comprising:
determining a first corresponding player compatible with a first entry for rendering the content defined by the first entry;
determining a second corresponding player compatible with a second entry for rendering the content defined by the second entry;
rendering the received content defined by the first entry; and
rendering the received content defined by the second entry, the first corresponding player different than the second corresponding player.

3. The method of claim 1 further comprising:
receiving, from the GUI, a request to commence rendering;
selecting, from among the instantiated players, the corresponding player based on the source of the content; and
invoking the corresponding player for rendering the media.

4. The method of claim 3 wherein determining the corresponding player further comprises mapping the entry to the corresponding player from among a plurality of players, the plurality of players invokable in response to other entries of the plurality of entries.

5. The method of claim 1 further comprising:
identifying a plurality of players for availability as the corresponding player;
determining, in an invokable interface for each player of the plurality of players, a set of commands for controlling rendering of the content, the invokable interface responsive to the commands from the GUI, the GUI adapted to issue commands to each of the players in response to user input.

6. The method of claim 5 wherein the invokable interface is defined by a set of messages, each of the players configured for rendering media from a corresponding source based on the defined set of messages, each invokable interface defining a set of messages independent and different from invokable interfaces defined for other players of the plurality of players.

7. The method of claim 1 wherein instantiating the players further comprises:
launching the GUI, the GUI responsive to user commands directed to the rendered content; and
invoking a player interface for each of the players corresponding to the sources of the plurality of entries, the GUI configured to direct content playback control messages to the player interface corresponding to the source of the content currently being rendered.

8. The method of claim 1 further comprising:
receiving a search entity, the search entity based on the entry and indicative of content adapted for rendering;
searching for at least one source containing the content;
searching, based on an identifier of the content adapted for rendering, static information associated with the content; and
rendering the static information in conjunction with rendering the content.

9. The method of claim 1 wherein the player is configured to locate and retrieve the content in a stream of information, the stream remaining impersistent during rendering.

10. The method of claim 8 further comprising:
identifying a storage location for the received content, the storage location for storing the content following retrieval from the source until rendering; and
maintaining the content in the storage location for a predetermined interval following rendering; and
deleting the supporting information from the storage location.

11. The method of claim 6 wherein the messages are defined by a transmission, invocation or call configured to transfer control from the GUI to the player performing the rendering, the transfer of control including mapping an input received by the GUI to a function of the player.

12. The method of claim 6 further comprising intercepting a message from the player indicative of player operation and translating the intercepted message to a GUI operation indicative of rendering.

13. The method of claim 8 further comprising:
determining that the source is encumbered by dependencies for access; and
performing at least one of obtaining an authorization that satisfies the dependency, or identifying an alternate source for satisfying the sought content.

14. A mobile device, comprising:
an application for organizing and rendering media files;
a plurality of playlists, the application responsive to the playlists for identifying, for each of a plurality of entries on a playlist, a source for rendering content defined by each entry in the plurality of entries;
a heterogeneous player configured to determine, for each entry, a corresponding player compatible with the entry for rendering the content, the heterogeneous player operable to instantiate and invoke the corresponding player via a message exchange to the corresponding instantiated player for rendering the entry, the corresponding player responsive to a common graphical user interface (GUI) for exchanging rendering commands;
a network interface configured to receive, from the identified source, the content for rendering and directing the content to the corresponding player; and
a speaker and screen to render the received content via the GUI and the corresponding player.

15. The device of claim 1 wherein the GUI is operable to:
issue a request to the player to commence rendering by selecting, from among the instantiated players, the corresponding player based on the source of the content and invoke the corresponding player for rendering the media.

16. The device of claim 15 wherein determining the corresponding player further comprises mapping the entry to the corresponding player from among a plurality of players, the plurality of players invokable in response to other entries of the plurality of entries.

17. The device of claim 14 wherein instantiating the players further comprises:
a player interface for each of the players corresponding to the sources of the plurality of entries, the GUI configured to direct content playback control messages to the player interface corresponding to the source of the content currently being rendered, the GUI responsive to user commands directed to the rendered content.

18. The device of claim 14 further comprising an interface to a media server, the media server configured to:
receive a search entity, the search entity based on the entry and indicative of content adapted for rendering;
search for at least one source containing the content; and
search, based on an identifier of the content adapted for rendering, static information associated with the content,
the app configured to invoke the interface for rendering the static information in conjunction with rendering the content.

19. The device of claim 8 further comprising:
identifying a storage location for the supporting information, the storage location for storing the content following retrieval from the source until rendering; and
maintaining the supporting information in the storage location for a predetermined interval following rendering; and
deleting the supporting information from the storage location.

20. A computer program product on a non-transitory computer readable storage medium having instructions that, when executed by a processor, perform a method of organizing and rendering media files, the method comprising:
identifying, for each of a plurality of entries on a playlist, a source for rendering content defined by each entry in the plurality of entries;
determining, for each entry, a corresponding player compatible with the entry for rendering the content;
instantiating the corresponding player on a user device, the corresponding player responsive to a common graphical user interface (GUI) for exchanging rendering commands received from the user device with the corresponding player;
receiving, from the identified source, the content for rendering and directing the content to the corresponding player;
exchanging, with the GUI, messages to the corresponding instantiated player for rendering the entry; and
rendering the received content via the GUI and the corresponding player.
